(19) United States
(12) Patent Application Publication
(10) Pub. No.: US 2011/0070500 A1
(43) Pub. Date: Mar. 24, 2011

(54) Electrode Material, Forming Method and Application Thereof

(75) Inventors: Yui-Whei Chen, Tao-Yuan (TW); Po-Chun Chuang, Tao-Yuan (TW); Chien-Min Chang, Tao-Yuan (TW)

(73) Assignee: Chung Yuan Christian University, Tao-Yuan (TW)

(21) Appl. No.: 12/727,826

(22) Filed: Mar. 19, 2010

(30) Foreign Application Priority Data
Sep. 18, 2009 (TW) 098131582

(51) Int. Cl. H01M 4/48; H01M 4/88; H01B 1/08

(52) U.S. Cl. 429/231.95; 252/182.1; 252/518.1

(57) ABSTRACT

An electrode material includes a particle-shaped crystalline metal oxide and further includes a particle-shaped amorphous metal oxide that is porous with a pore volume greater than or equal to 0.5 cm³/g. The electrode material can be formed and applied in the context of a lithium secondary battery.

### CROSS-REFERENCE TO RELATED APPLICATIONS

The entire contents of Taiwan Patent Application No. 098131582, filed on Sep. 18, 2009, from which this application claims priority, are incorporated herein by reference.

### BACKGROUND OF THE INVENTION

1. Field of the Invention

The present invention relates to an electrode material, and more particularly, to an electrode material of a lithium secondary cell, along with its construct, formation, and application.

2. Description of Related Art

The capacity of an electrochemical cell, such as a lithium secondary cell, should be high and very much depends on the capacitances per unit weight of its positive electrode and negative electrode materials. Taking the lithium secondary cell as example, most prior-art techniques employ crystalline metal oxide, such as LiCoO₂, LiNiO₂, LiMn₂O₄, and LiFePO₄, as the positive electrode material. In these electrodes, the numbers of lithium ions intercalated in and deintercalated from the structure of the electrode material are limited; when the electrode contains too many or too few ions, the crystalline structure is easily collapsed and/or altered irreversibly, resulting in a decrease of the electrode's electroactivity thereby undesirably decreasing the capacity of the electrochemical cell.

A few prior-art approaches have employed amorphous metal oxide as the positive electrode material. By doing so, although the lithium-ion diffusion is faster, cycle-ability is superior, with the capacity of the electrochemical cell being increased as well. Generally, manufacturing costs of cells fabricated with amorphous metal oxides are significantly increased. Furthermore, considerable binder and conductive materials are required for the manufacture of such electrodes. Therefore, electrode materials of pure amorphous metal oxides have not been commercially adopted.

Accordingly, a novel electrode material with excellent electrochemical properties and less manufacturing costs is needed, or at least worthwhile of pursuit, for the commercial electrochemical cells.

### SUMMARY OF THE INVENTION

An object of the present invention is to provide an electrode of novel material, forming method, and application, which has excellent electrochemical properties and a reduced manufacturing cost.

According to the object, the present invention provides an electrode material that comprises a particle-shaped crystalline metal oxide and a particle-shaped amorphous metal oxide, wherein the amorphous metal oxide is a porous material with a pore volume greater than or equal to about 0.5 cm³/g.

According to the object, the present invention provides a lithium secondary cell that comprises a first electrode, a second electrode, and an electrolyte arranged between the first electrode and the second electrode. The first electrode comprises a particle-shaped crystalline metal oxide and further comprises a particle-shaped amorphous metal oxide that is porous with a pore volume greater than or equal to about 0.5 cm³/g, and the second electrode is electrically opposite to (e.g., has an opposite electrode polarity relative to) the first electrode.

According to the object, the present invention also provides a method for forming an electrode material. The method comprises: providing a metal oxide precursor; performing a sol-gel reaction on the metal oxide precursor, the sol-gel reaction comprising an ionic liquid and a solvent and employing the ionic liquid as a template to form an amorphous metal oxide aerogel; drying the amorphous metal oxide aerogel to form a particle-shaped amorphous metal oxide; and physically mixing a particle-shaped crystalline metal oxide with the particle-shaped amorphous metal oxide to form an electrode material.

### BRIEF DESCRIPTION OF THE DRAWINGS

FIG. 1 shows a forming method of the amorphous metal oxide of an electrode material according to one embodiment of the present invention.

FIG. 2 shows how each of the five vanadium pentoxide materials, A, B, C, D and Cm, shown in Table 1 can be employed to produce electrode materials according to one embodiment of the present invention.

FIG. 3 shows X-ray diffraction (XRD) measurements of A, B, C, D and Cm.

FIG. 4 shows transmission electron microscopy (TEM) images of A (a vanadium pentoxide aerogel) and Cm (a crystalline metal oxide) produced by the present invention.

FIG. 5 shows scanning electron microscope (SEM) images of an electrode E-A produced from A and an electrode E-Cm produced from Cm.

FIG. 6 shows cyclic voltammograms of the electrode E-A and the electrode E-Cm.

FIG. 7 shows specific capacitances of the five electrodes shown in Table 2 at 5^{th}, 10^{th}, 15^{th}, and 20^{th} cycles.

FIG. 8 is a bar chart showing the relationship between the pore volume and the specific capacitances of the five electrodes at 20^{th} cycle.

FIG. 9 shows stabilities of the electrodes E-A and E-Cm.

FIG. 10 shows cycle-abilities of the electrodes calculated from FIG. 9.

FIG. 11 compares the first discharge and first charge between a cell with electrode E-Cm and a cell with electrode E-A.

FIG. 12 compares the tenth charge and tenth discharge between the cell with electrode E-Cm and the cell with electrode E-A.

### DESCRIPTION OF THE PREFERRED EMBODIMENT

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations have not been described in detail in order not to obscure unnecessarily the present invention. While the drawings are illustrated in detail, it is to be appreciated that the quantity of the disclosed components may be greater or less than that disclosed, except for instances expressly restricting the amount of the components.

The present invention provides a composite material (also referred to as an “electrode material” in this text) applied to an electrode. In contrast to prior-art implementations, the composite (e.g., electrode) material of the invention is mixed from a crystalline metal oxide and an amorphous metal oxide. According to the present invention, mixing of the crystalline metal oxide and the amorphous metal oxide provides much better and more stable paths for the intercalation and deintercalation of the electrolyte ions. Accordingly, the embodiments of the present invention physically mix the particle-shaped crystalline metal oxide (being nearly 100% crystalline) with the particle-shaped amorphous metal oxide in predetermined percentages, and may further mix with binder, conductive material, and optional dopants or fillers to form the composite material. Later in this description, the composite material is used to form electrodes followed by structures and properties of the resulting electrodes being discussed.

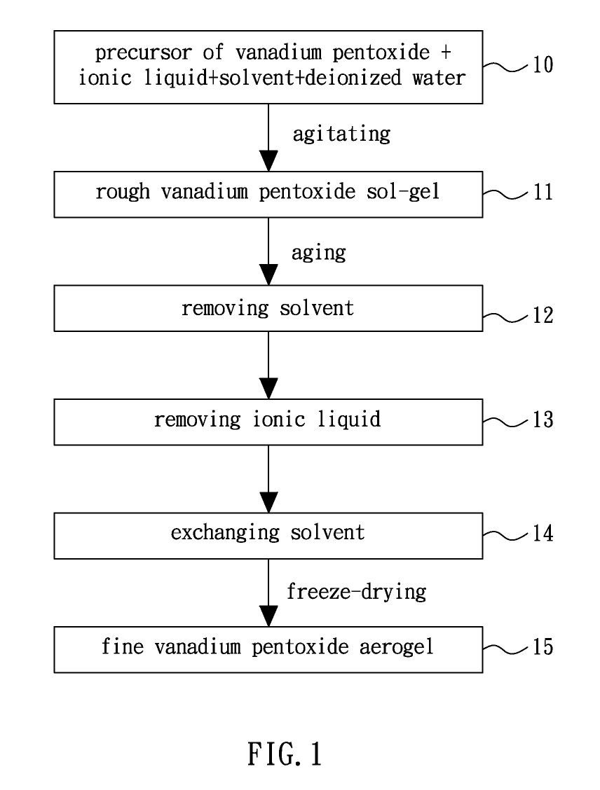

FIG. 1 shows a forming method of the amorphous metal oxide of an electrode material according to one embodiment of the present invention. This embodiment employs vanadium pentoxide (V₂O₅) as the metal oxide, and uses Sol-gel synthesis method (by using an ionic liquid as the template) and freeze-drying method to produce a vanadium pentoxide aerogel, i.e., an amorphous metal oxide.

As shown in FIG. 1, the method begins at step 10 with the adding of a precursor of vanadium pentoxide, a solvent, and de-ionized water at a predetermined ratio, such as with a molar ratio 1:50:40, into a container. In this example, Vanadium oxytripropoxide (VO(OCH₂CH₂CH₃)₃) or Vanadium oxytriisopropoxide (VO(OCH(CH₃)₂)₃) is selected as the precursor of vanadium pentoxide, and isopropanol or acetone is selected as the solvent. Later, 1-Butyl-3-methylimidazolium Tetrafluoroborate, an ionic liquid, is selected as a template and is added into the above solution. The ionic liquid may be 20 wt % of total sample solution. At step 11, the mixing solution is well agitated, and thus a vanadium pentoxide wet-gel is obtained. At step 12, the vanadium pentoxide wet-gel is aged under room temperature for 5 days to stabilize its structure, and then the solvent is removed. For example, the solvent may be removed by unsealing the container followed by the solvent being vaporized. At step 13, the ionic liquid is removed from the sample. For example, the sample may be placed into a Soxhlet extractor, and then an optional step, step 14, is used to exchange the ionic liquid by another solvent. In step 15, the sample is frozen by liquid nitrogen and then placed in a freeze-drying machine for drying, such that a fine vanadium pentoxide aerogel is obtained.

Because the above-mentioned method employs two different precursors and two different solvents, a total of four different vanadium pentoxide aerogels can be produced. The abbreviations, A, B, C, and D, are used to distinguish them, as shown below in Table 1, along with the crystalline vanadium pentoxide, Cm, which can be obtained from commercial products.

TABLE 1

| sample | solvent | precursor |
|---|---|---|
| A | isopropanol | VO(OCH(CH₃)₂)₃ (vip) |
| B | isopropanol | VO(OCH₂CH₂CH₃)₃ (vp) |
| C | acetone | VO(OCH(CH₃)₂)₃ (vip) |
| D | acetone | VO(OCH₂CH₂CH₃)₃ (vp) |

| | |
|---|---|
| Cm | crystalline vanadium pentoxide |

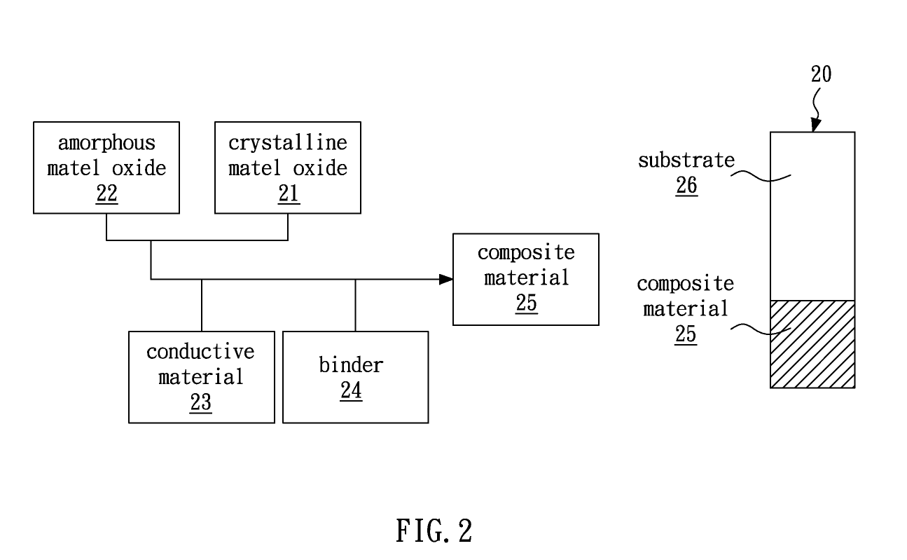

Then, FIG. 2 shows how each of five samples (i.e., each of five vanadium pentoxide materials) A, B, C, D and Cm as shown in Table 1 can be employed to produce electrode materials according to one embodiment of the present invention. First, a crystalline metal oxide 21 (in this example crystalline vanadium pentoxide is used as the crystalline metal oxide) and an amorphous metal oxide 22 (in this example vanadium pentoxide aerogel is used as the amorphous metal oxide) are physically mixed with a predetermined weight ratio, such as 70 wt %:30 wt %, and preferable 90 wt %:10 wt %. The mixing method should not be limited and the mixers used may comprise a physical agitator, a mixing tank with blade, a centrifugal mixer, and the like. In addition, the crystalline metal oxide may be ground into particles before it is mixed with the amorphous metal oxide. In one embodiment of the present invention, the crystalline metal oxide is ground into particles having an average particle size of about 2-3 μm. In another embodiment of the present invention, the crystalline metal oxide is ground into particles having an average particle size of about 500 nm. The later case may be advantageous for a more uniform type of mixing, but the processing time may be extended and the processing conditions are more rigorous. In contrast, because the amorphous metal oxide 22 (in this example, vanadium pentoxide aerogel) is relatively loose and brittle, and its shape is that of a powder or particles with an average particle size of about 100-200 nm (produced by the method mentioned in FIG. 1), the grinding can be therefore skipped.

Uniformly mixing the particle-shaped crystalline metal oxide 21 and the particle-shaped amorphous metal oxide 22 can obtain a composite material 25, wherein the ratio of the weight of the amorphous metal oxide particle 22 to the weight of the crystalline metal oxide particle 21 is equal to or smaller than 3:7, and in one embodiment, the ratio is about 1:9. Simultaneously or later, a (electrical) conductive material 23 such as conductive carbon and a binder 24 such as polyvinylidene difluoride (PVDF), which is dissolved in a solvent such as N-Methyl-2-Pyrrolidone (NMP), may be added into the composite material 25. In this example, the weight percentage of the crystalline metal oxide 21, the amorphous metal oxide 22, the conductive material 23, and the binder 24 is about 63 wt %, 7 wt %, 20 wt %, 10 wt %, respectively, but this should not be limited. The composite material 25 is mixed uniformly for about 1 day and then coated on a substrate 26, which is made of metal or other material having a metal surface. The coating area is about 1 cm²; then, the substrate 26 may be placed in a vacuum oven to be heated at 100° C. for 6 hours to vaporize the remaining solvent from the substrate 26, and an electrode 20 is then obtained.

By the method elucidated in FIG. 2, the above five materials listed in Table 1 can be used to produce five electrodes, as shown in Table 2. Following a description of that production, the structure and the properties of the five electrodes will be discussed.

TABLE 2

| Electrode | Composition of 70 wt % (crystalline + amorphous) |
|---|---|
| Sample | metal oxide |
| E-A | 10 wt % A + 90 wt % Cm |
| E-B | 10 wt % B + 90 wt % Cm |
| E-C | 10 wt % C + 90 wt % Cm |
| E-D | 10 wt % D + 90 wt % Cm |
| E-Cm | 100 wt % Cm |

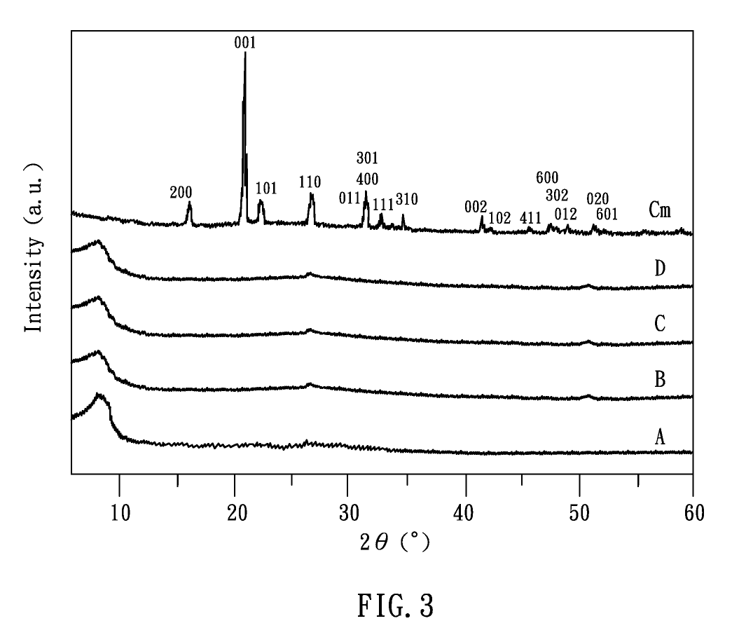

FIG. 3 shows X-ray diffraction (XRD) measurements of A, B, C, D and Cm. Compared with the XRD curve (PDF#41-1426) in JCPDS, the curve for Cm shows that the structure of the crystalline metal oxide is orthorhombic, and the curves for A, B, C and D show that the four vanadium pentoxide aerogels produced by the embodiments of the present invent are amorphous.

Table 3 is the BET surface area analysis result of the five vanadium pentoxides listed in Table 1. The BET analysis shows that the specific surface area and the pore volume of the four vanadium pentoxide aerogels are 27 to 89 and 40 to 197 times greater than that of the crystalline metal oxide, respectively. In addition, the vanadium pentoxide aerogel A and B, that use isopropanol as the solvent has larger specific surface and larger pore volume than the corresponding aerogel, that use acetone as the solvent, C and D, respectively, at the condition using the same precursor; and the vanadium pentoxide aerogel, A, that uses vanadium oxytriisopropoxide (vip) as the precursor and isopropanol as the solvent has the largest pore volume.

TABLE 3

| | specific surface area | pore volume | pore diameter |
|---|---|---|---|
| sample | (m²/g) | (cm³/g) | (nm) |
| A | 173 | 1.22 | 23.5 |
| B | 231 | 1.04 | 16.1 |
| C | 69 | 0.59 | 31.1 |
| D | 75 | 0.25 | 11.1 |
| Cm | 2.8 | 0.0062 | 11.9 |

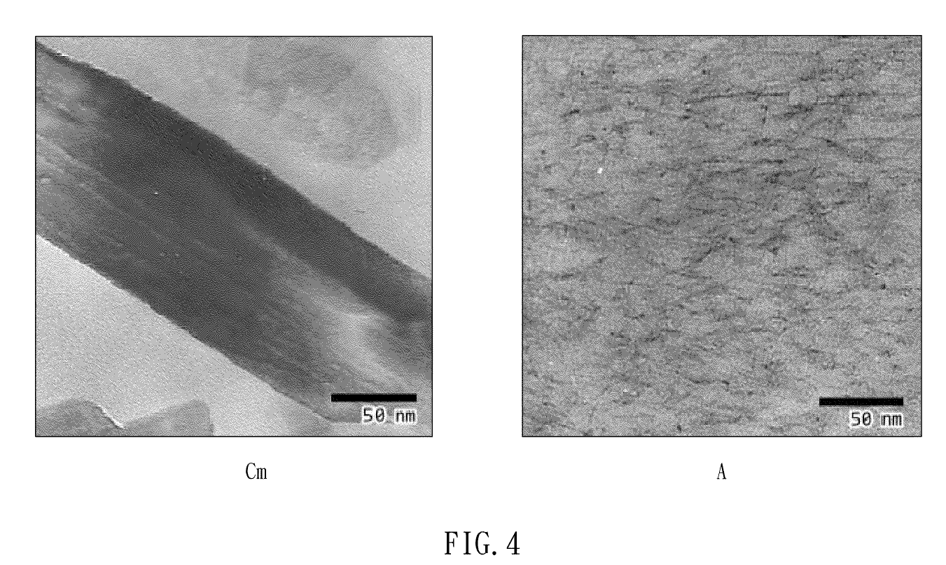

FIG. 4 depicts transmission electron microscopy (TEM) measurements of A (a composite material, e.g., vanadium pentoxide aerogel) and Cm (a crystalline metal oxide), as produced by the present invention. The TEM results show that the surface of Cm is basically pore-free, while A contains numerous pores of about 5 nm or less in diameter.

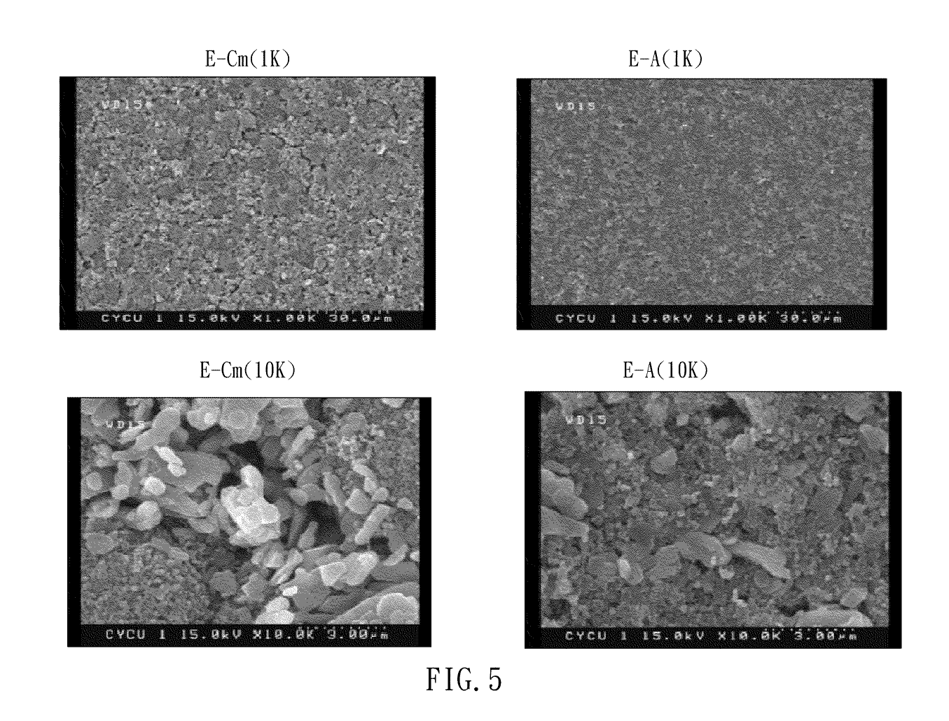

FIG. 5 shows scanning electron microscope (SEM) measurements of an electrode E-A produced from A and an electrode E-Cm produced from Cm. For simplicity, the SEM results of other electrodes are not shown. The SEM with 1K magnification shows that the electrode E-Cm contains numerous dark, ball-shaped conductive carbon particles, which are about 6 μm in diameter and are uniformly distributed with numerous shining metal oxide crystallines. The SEM with 10K magnification shows that the electrode E-Cm is constructed by stacked large crystalline metal oxide particles, and many voids appeared between the stacked crystalline metal oxide particles. In contrast, although the electrode E-A is constructed by the uniformly distributed vanadium pentoxide particles and conductive carbons as well, the smaller A particles are filled in the voids between the crystalline metal oxide particles; therefore the contact area between the electrode material and the electrolyte is increased. Thus, more intercalation sites can be provided.

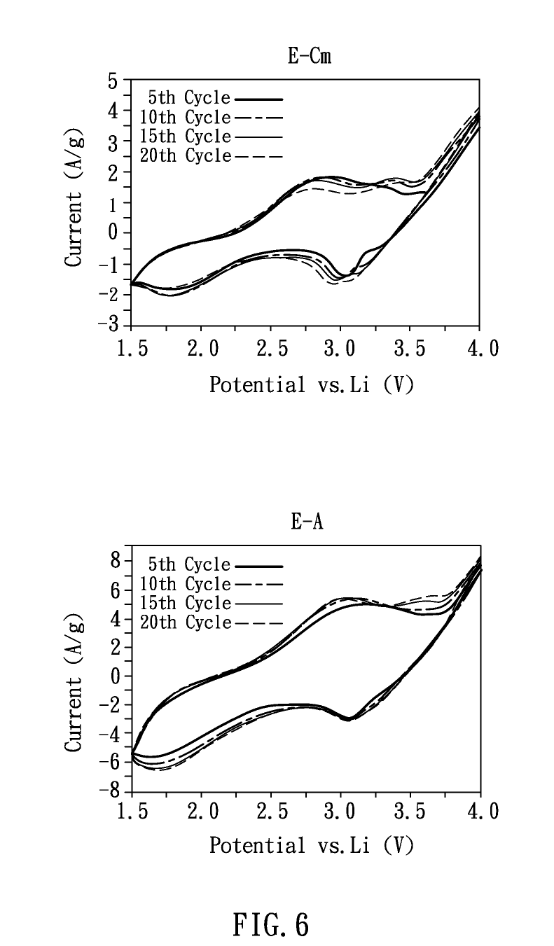

FIG. 6 shows cyclic voltammetry (CV) measurements of the electrode E-A and the electrode E-Cm. For simplicity, the CV results of other electrodes are not shown. The CV is measured by a three-electrode electrochemical analysis system, where the as-prepared electrode is used as the working electrode, the metal lithium is used as the reference electrode and counter electrode, the electrolyte is 1M LiClO₄/PC, and the voltage range is from 0 to 4 V at 10 mV/s. The CV measurements show that the original oxidative peak and reductive peak of electrode E-Cm are at 2.8 V and 3.0 V, respectively. When the number of cycles is increased, the oxidative peak is shifted due to the collapse or structure change of the crystalline vanadium pentoxide; in contrast, the original oxidative peak and reductive peak of electrode E-A are at 3.0 V and 3.1 V, respectively. When the number of cycles is increased, the oxidative peak is also shifted due to the collapse or structure change of the crystalline vanadium pentoxide, but the oxidative peak is not weakened because the added amorphous vanadium pentoxide's structure does not collapse. Thus, the stability of electrode E-A is superior to that of electrode E-Cm.

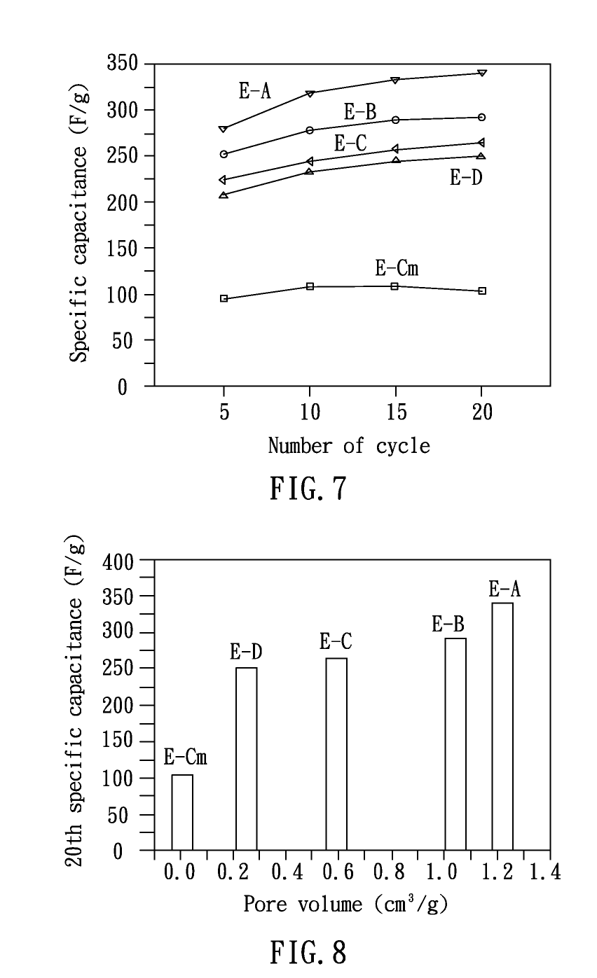

The specific capacitances of the electrodes can be calculated from the cycling area (area under curve) of the CV measurement. FIG. 7 depicts specific capacitances of the five electrodes of Table 2 at 5^{th}, 10^{th}, 15^{th}, and 20^{th} cycles. The results show that the specific capacitances of electrodes E-A, E-B, E-C, and E-D are all increased with increasing numbers of cycles. Compared with that of electrode E-Cm, the specific capacitances of the 20^{th} cycle of electrodes E-A, E-B, E-C, and E-D are additionally increased to levels from about 247 F/g through about 337 F/g, which are about 2.4 to 3.3 times greater than the specific capacitance of the electrode E-Cm.

FIG. 8 is a bar chart depicting the relationship between specific capacitances of the five electrodes at 20^{th} cycle and the pore volume of the corresponding vanadium pentoxide aerogel. The bar chart shows that the specific capacitance of an electrode is increased with increasing the pore volume of the vanadium pentoxide aerogel. Electrode E-Cm has the lowest specific capacitance 103 F/g (with a lowest pore volume of almost 0 cm³/g) and electrode E-A has the largest specific capacitance 340 F/g (with largest pore volume, about 1.2 cm³/g). This is due to the large pore volume providing more diffusion space for the lithium electrolyte, resulting in more sites intercalated.

Then, the capacities of the electrodes are measured by charge and discharge test with constant current. The test system used for the capacity measurement is the same three-electrode-electrochemical system used for the CV measurement, where the electrolyte is 1M LiClO₄/(PC/EC), and the test condition is 2 to 3.5 V (charge) and 1 C (discharge). The discharging rate C is defined as the capacity discharged per hour (mA/hr). If the nominal capacity of one cell is 1000 mAhr⁻¹, the discharging rate 1 C is 1000 mA per hour, and discharging rate C/10 is 100 mA per hour.

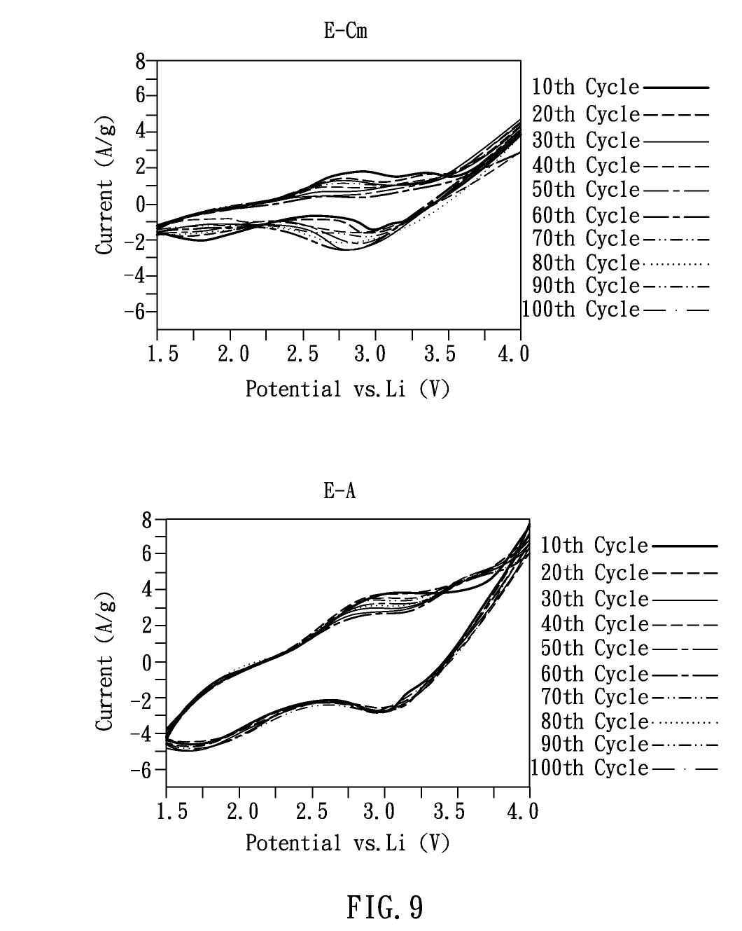

FIG. 9 depicts the stabilities of electrodes E-A and E-Cm. The results show that the oxidative and reductive peaks of the electrode E-Cm are shifted and weaker as the number of cycles is increased; in contrast, the oxidative peak of the electrode E-A is slightly shifted but is not weakened, and the reductive peak is neither shifted nor weakened after 100 cycles. This confirms that the stability of electrode E-A is superior to that of electrode E-Cm.

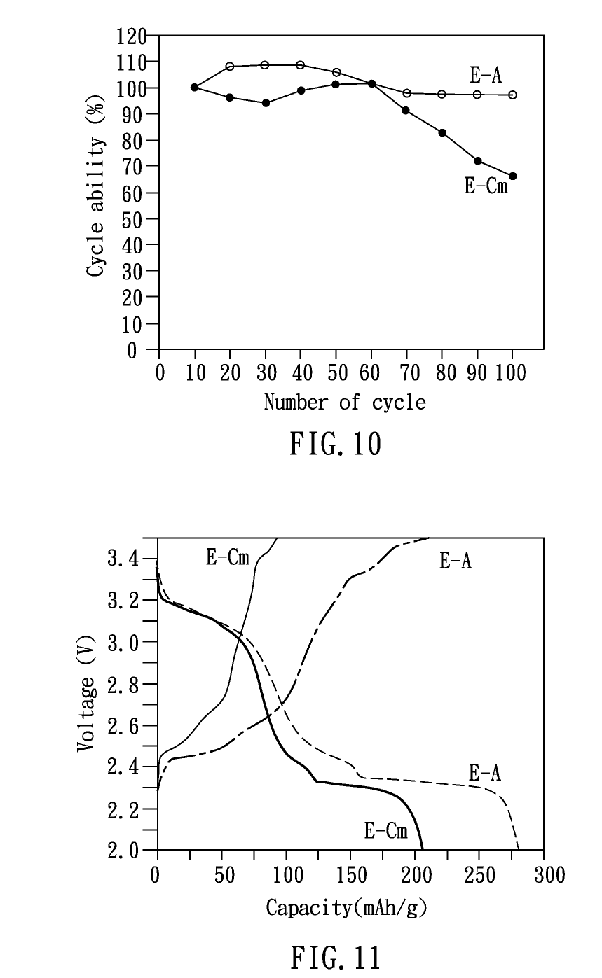

The cycle-abilities of the electrodes can be calculated from FIG. 9, and the calculated values are depicted in FIG. 10. The results show that the cycle-ability of electrode E-A is superior to that of electrode E-Cm. Referring to the electrode E-Cm, the cycle-ability of 100^{th} cycle is only 66% of the cycle-ability at 10^{th} cycle; referring to the electrode E-A, the cycle ability of 100^{th} cycle is 97% of the cycle ability at 10^{th} cycle, revealing excellent cycle-ability. The above results prove that electrodes made of the composite materials by the embodiments of the present invention have excellent cycle-ability. This is because the added vanadium pentoxide aerogel is an amorphous material with large surface area and pore volume, whereby the electrolyte can be easily intercalated and deintercalated during the oxidation and reduction; therefore, the mix of crystalline vanadium pentoxide with the vanadium pentoxide aerogel forms an electrode material that can largely suppress the problem of collapse or structure change, and that maintains excellent cycle-ability even after long-term operation.

FIG. 11 provides a comparison of the first discharge and first charge results between electrode E-Cm and electrode E-A. The capacity of the first discharge and discharge of the electrode E-Cm is 206 mAh/g and 94 mAh/g, respectively, while the capacity of the first discharge and charge of electrode E-A is 280 mAh/g and 213 mAh/g, respectively. The irreversible capacity of each electrode can be estimated from the difference between the charge capacity and the discharge capacity. Accordingly, the estimated irreversible capacity of electrode E-Cm is 112 mAh/g, i.e., 54%; the irreversible capacity of electrode E-A is 67 mAh/g, i.e., 24%. Apparently, the electrode E-A outperforms the electrode E-Cm.

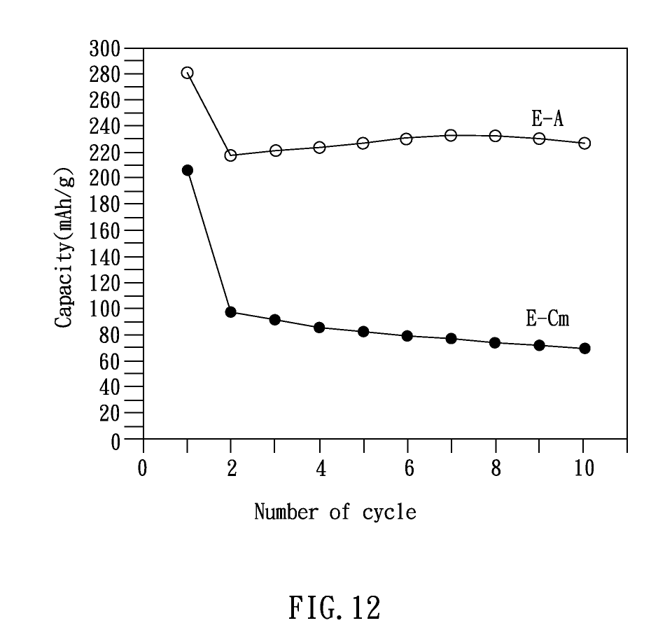

FIG. 12 presents a comparison of the tenth charge/discharge results between electrode E-Cm and electrode E-A. The capacity of electrode E-Cm is decreased from 97 mAh/g to 69 mAh/g after the second charge/discharge. The capacity of the tenth charge and discharge is only 71% of the capacity of the second charge and discharge. The electrode E-A obviously has larger capacity and better stability than electrode E-Cm. The capacity of electrode E-A is 150 mAh/g larger than that of electrode E-Cm, i.e., the capacity of electrode E-A is 2.7 times larger than that of electrode E-Cm. Moreover, after the second charge/discharge, the capacity of electrode E-A is not decreased as the number of charge/discharge is increased; moreover, the capacity of electrode E-A is slightly increased and maintained at about 225 mAh/g as the number of charge/discharge is increased.

The charge/discharge test results show that the electrode E-A produced by the embodiment of the present invention has better capacity, lower irreversible capacity, and better stability. This is ascribed to the large surface area and pore volume of the amorphous vanadium pentoxide aerogel that is mixed with the crystalline vanadium pentoxide in the electrode, suppressing the collapse or structure change of the crystalline vanadium pentoxide

In the above embodiment, the composite material that comprises crystalline vanadium pentoxide and vanadium pentoxide aerogel is used to produce the electrodes. The vanadium pentoxide aerogel not only has a large specific surface area and large pore volume, providing more intercalation sites for the electrolyte ions, but also has a smaller particle size than the crystalline vanadium pentoxide, filling in the voids between the crystalline vanadium pentoxide particles, whereby the capacity and cycle-ability of the electrode is enhanced, and the irreversible capacity of the electrode is reduced under fast charge/discharge rates.

In other embodiments of the present invention, properties of the electrode can be promoted by the same theory as mentioned above. For example, other metal oxides such as titanium dioxide (TiO₂), manganese dioxide (MnO₂), zinc oxide (ZnO) and tin dioxide (SnO₂) can be employed, and the amorphous, porous metal oxide with large specific surface and pore volume can be produced by other methods in other embodiments of the present invention. Moreover, the crystalline metal oxide and amorphous metal oxide can be two or more different metal oxides. According to the inventive concept of the present invention, the particle size of the crystalline metal oxide is not limited; its average may be microscale, nanoscale, or a uniform distribution of microscale and nanoscale, because regardless of the size of the crystalline metal oxide particles the voids between the crystalline metal oxide particles can be filled by the amorphous metal oxide particles that have similar or smaller size. In one embodiment of the present invention, the average size of the crystalline metal oxide particles is about 2 to 3 μm. In addition, one inventive implementation of the present invention requires that the amorphous metal oxide particle be a porous material having a large specific surface area and a large pore volume wherein “large pore volume” means at least equal to or larger than 0.5 cm³/g (or, ≧about 0.5 cm³/g), and preferably equal to or larger than 1 cm³/g (or, ≧about 1 cm³/g); “large specific surface area” means at least equal to or larger than 50 m²/g (or, ≧about 50 m²/g), and preferably equal to or larger than 100 m²/g (or, ≧about 100 m²/g).

In addition, the mixing ratio of the crystalline metal oxide and the amorphous metal oxide is not limited to the above embodiments; it can be other ratios. In one embodiment of the present invention, the ratio of the weight of the crystalline metal oxide to the weight of the amorphous metal oxide is about 70 wt %:30 wt %. In another embodiment, the ratio of the weight of the crystalline metal oxide to the weight of the amorphous metal oxide is about 90 wt %:10 wt % whereby the composite material with this ratio can produce an electrode having excellent properties. Other experiments of the present invention show that, when the weight percentage of the amorphous metal oxide is less than 10 wt %, such as 7 wt %, 5 wt %, and 2 wt %, of the total weight of crystalline metal oxide and amorphous metal oxide, the electrodes also have good properties.

Although the composite material of the above embodiments is mainly employed to produce the positive electrode of an electrochemical cell, it can be used to match different negative electrodes as well. For example, electrodes produced from the composite material of the embodiments can be used as the positive electrode of a rocking chair lithium cell or a lithium cell. Hence, different dopants or fillers may be added into the composite material for adjusting the properties of the electrodes. For example, the dopants or fillers may comprise ionic liquid, metals, lithium ions, lithium salts, and other materials capable of being intercalated/deintercalated by the lithium ion, such as LiCoO₂, LiNiO₂, LiMn₂O₄, and LiFePO₄. Further, other experiments of the present invention reveal that when the crystalline metal oxide or the amorphous metal oxide contains crystal water the properties of the electrode may be better.

The above disclosure shows that the properties of the electrode can be significantly improved by adding a little amorphous metal oxide with large pore volume into the electrode material, whereby the manufacturing cost is substantially reduced compared with that of an electrode produced from pure amorphous metal oxide; therefore, the electrode material and its application have potential as the best candidate for a new generation of electrode materials.

Although specific embodiments have been illustrated and described, it will be appreciated by those skilled in the art that various modifications may be made without departing from the scope of the present invention, which is intended to be limited solely by the appended claims.

What is claimed is:

1. An electrode material, comprising:
a particle-shaped crystalline metal oxide; and
a particle-shaped amorphous metal oxide, wherein the amorphous metal oxide particle shape is porous, and the pore volume of the amorphous metal oxide particle shape is greater than or equal to 0.5 cm³/g.

2. The electrode material as recited in claim 1, wherein the average size of the crystalline metal oxide particle shape is greater than or equal to 0.5 μm.

3. The electrode material as recited in claim 1, wherein the average size of the crystalline metal oxide particle shape is greater than or equal to 2 μm.

4. The electrode material as recited in claim 1, wherein the amorphous metal oxide particle shape is a porous material having a large specific surface area and a large pore volume.

5. The electrode material as recited in claim 1, wherein the pore volume of the amorphous metal oxide particle shape is greater than or equal to 1 cm³/g.

6. The electrode material as recited in claim 1, wherein the specific surface area of the amorphous metal oxide particle shape is greater than or equal to 50 m²/g.

7. The electrode material as recited in claim 1, wherein the specific surface area of the amorphous metal oxide particle shape is greater than or equal to 100 m²/g.

8. The electrode material as recited in claim 1, wherein the crystalline metal oxide and the amorphous metal oxide are selected from the group consisting of vanadium pentoxide (V₂O₅), titanium dioxide (TiO₂), manganese dioxide (MnO₂), zinc oxide (ZnO), tin dioxide (SnO₂), and combination thereof.

9. The electrode material as recited in claim 1, wherein the ratio of the weight of the amorphous metal oxide particle shape to the weight of the crystalline metal oxide particle shape is equal to or smaller than 3:7.

10. The electrode material as recited in claim 1, wherein the ratio of the weight of the amorphous metal oxide particle shape to the weight of the crystalline metal oxide particle shape is about 1:9.

11. The electrode material as recited in claim 1, further comprising a conductive material and a binder.

12. The electrode material as recited in claim 11, wherein the composition of the electrode material includes the crystalline metal oxide particle shape 63 wt %, the amorphous metal oxide particle shape 7 wt %, the conductive material 20 wt %, and the binder 10 wt %.

13. The electrode material as recited in claim 11, further comprising a material capable of being intercalated/deintercalated by a lithium ion.

14. The electrode material as recited in claim 11, wherein the amorphous metal oxide particle shape comprises crystal water and/or an ionic liquid.

15. A lithium secondary cell, comprising:
a first electrode, comprising a particle-shaped crystalline metal oxide and a particle-shaped amorphous metal oxide, wherein the amorphous metal oxide particle shape is porous, and the pore volume of the amorphous metal oxide particle shape is greater than or equal to 0.5 cm³/g;
a second electrode, being an opposite electrode of the first electrode; and
an electrolyte arranged between the first electrode and second electrode.

16. A method for forming an electrode material, comprising:
providing a metal oxide precursor;
performing a sol-gel reaction of the metal oxide precursor wherein the sol-gel reaction comprising an ionic liquid and a solvent, and employing the ionic liquid as a template to form an amorphous metal oxide aerogel;
drying the amorphous metal oxide aerogel to form a particle-shaped amorphous metal oxide; and
physically mixing a particle-shaped crystalline metal oxide with the particle-shaped amorphous metal oxide to form an electrode material.

17. The method as recited in claim 16, wherein the metal oxide precursor is a precursor of vanadium pentoxide, and the metal oxide precursor is selected from the group consisting of vanadium oxytripropoxide (VO(OCH₂CH₂CH₃)₃) and vanadium oxytriisopropoxide (VO(OCH(CH₃)₂)₃).

18. The method as recited in claim 16, wherein the solvent is selected from the group consisting of isopropanol and acetone.

19. The method as recited in claim 16, wherein the average size of the crystalline metal oxide particle shape is greater than or equal to 0.5 μm.

20. The method as recited in claim 16, wherein the average size of the crystalline metal oxide particle shape is greater than or equal to 2 μm.

21. The method as recited in claim 16, wherein the pore volume of the amorphous metal oxide particle shape is greater than or equal to 0.5 cm³/g.

22. The method as recited in claim 16, wherein the pore volume of the amorphous metal oxide particle shape is greater than or equal to 1 cm³/g.

23. The method as recited in claim 16, wherein the specific surface area of the amorphous metal oxide particle shape is greater than or equal to 50 m²/g.

24. The method as recited in claim 16, wherein the specific surface area of the amorphous metal oxide particle shape is greater than or equal to 100 m²/g.

25. The method as recited in claim 16, wherein the amorphous metal oxide particle shape comprises crystal water and/or an ionic liquid.

26. The method as recited in claim 16, wherein the ratio of the weight of the amorphous metal oxide particle shape to the weight of the crystalline metal oxide particle shape is equal to or smaller than 3:7.

27. The method as recited in claim 16, wherein the ratio of the weight of the amorphous metal oxide particle shape to the weight of the crystalline metal oxide particle shape is about 1:9.

28. The method as recited in claim 16, further comprising mixing a conductive material and a binder.

29. The method as recited in claim 16, further comprising mixing a material capable of being intercalated/deintercalated by a lithium ion.
